(19) United States
(12) Patent Application Publication
(10) Pub. No.: US 2021/0076633 A1
(43) Pub. Date: Mar. 18, 2021

(54) MILKING SYSTEM AND METHOD

(71) Applicant: Bullseye Australia PTY LTD, Beaconsfield (AU)

(72) Inventor: Richard Paul Wallace, Beaconsfield (AU)

(21) Appl. No.: 16/970,294

(22) PCT Filed: Feb. 15, 2019
(86) PCT No.: PCT/AU19/50125

§ 371 Date: Aug. 14, 2020

(30) Foreign Application Priority Data
Feb. 15, 2018 (AU) 2018900481

(51) Int. Cl. A01J 5/16; A01J 5/007

(52) U.S. Cl. CPC A01J 5/16; A01J 5/007

(57) ABSTRACT

Disclosed herein is a method of milking a cow using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including: Applying a vacuum to the lower end of the liner; Modulating the pressure in the pulsation volume according to a pulsation cycle to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat wherein the pulsation cycle has a duration of less than 1 second.

The applicant has previously disclosed in their earlier international patent application PCT/AU2017/050412 methods and systems for milking cows which can advantageously lead to better animal health. The methods disclosed therein use the application of positive air pressure during the “C phase” of the pulsation cycle to rapidly close the milking cup liner on the cow's teat. In combination with a lower overall vacuum applied to the teat during the “A” and “B” phases and milking cup inserts or a profiled shell to control the movement of the milking cup liner during the A phase, the present inventor has now determined further advantageous methods of milking which can be employed.

### FIELD OF THE INVENTION

The present invention relates to methods of milking mammals. In particular, the present invention relates to methods for use in the milking of cows.

### BACKGROUND OF THE INVENTION

### Summary of the Invention

In a first aspect there is provided a method of milking a cow using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:
Applying a vacuum to the lower end of the liner;
Modulating the pressure in the pulsation volume according to a pulsation cycle to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat wherein the pulsation cycle has a duration of less than 1 second.

In a second aspect there is provided a method of milking a cow using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:
Applying a vacuum to the lower end of the liner;
Modulating the pressure in the pulsation volume according to a pulsation cycle to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat;
wherein the pulsation cycle includes a

B phase in which the teat is exposed to a vacuum by opening of open liner bore, and said B phase has a duration of less than 450 ms.

In a third aspect there is provided a method of milking a cow using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:
Applying a vacuum to the lower end of the liner;
Modulating the pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat;
wherein a modulation pattern of the pressure in the pulsation volume defines a pulsation cycle including at least:
a “B phase” in which the teat is exposed to a vacuum by opening of open liner bore,”;
a “D” phase in which the liner bore is closed around the teat;
an “A phase” corresponding to a transition between the D phase and B phase; and
a “C phase” corresponding to a transition between the B phase and D phase;
   wherein over a multiplicity of pulsation cycles the A phase and C phases have approximately constant duration and the B phase is a duration of less than 450 ms.

In a fourth aspect there is provided a method of milking a cow using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:
Applying a vacuum to the lower end of the liner;
Modulating the pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat;
wherein a modulation pattern of the pressure in the pulsation volume defines four phases in a pulsation cycle comprising:
wherein a modulation pattern of the pressure in the pulsation volume defines a pulsation cycle including at least:
a “B phase” in which the teat is exposed to a vacuum by opening of open liner bore,”;
a “D” phase in which the liner bore is closed around the teat;
an “A phase” corresponding to a transition between the D phase and B phase; and
a “C phase” corresponding to a transition between the B phase and D phase;
   wherein the duration of the C phase is controlled by the application of positive pressure air to the pulsation volume, and the duration of the A phase is controlled by a flow restriction to air entering or exiting the pulsation volume.

The method in any of the abovementioned aspects can include providing collapsing means to cause sequential collapse of the liner against the teat from the lowermost part of the teat.

The collapsing means can include either or both of:
an insert placed within the pulsation volume
a profiled inner surface of the shell.

The method in any of the abovementioned aspects can further include:
determining a pressure in the bore; and
applying a positive pressure to the pulsation volume in the off phase, wherein the level of positive pressure applied is determined on the basis of said determined pressure.

In a method of any of the abovementioned aspects the vacuum applied to the lower end of the liner can be between 34 kPa and 38 kPa. Preferably it is about 35 kPa.

The method in any of the abovementioned aspects can include applying compressive load to the teat in a manner that causes application of said load at the lowermost part of the teat before the application of compressive load higher up the teat. Compressive load is preferably initially applied to the lowermost 1 to 3 mm of the teat.

In any of the abovementioned aspects the pulsation cycle may have a duration selected from any one or more of the following:
less than 950 ms, less than 900 ms; less than 850 ms; less than 800 ms; less than 750 ms; less than 700 ms; less than 675 ms; at or about 674 ms; 600 ms or above; 650 ms or above; 700 ms or above; 7500 ms or above; 800 ms or above; 850 ms or above; 900 ms or above; 950 ms or above; or within a range defined by any pair of the above listed durations.

In any of the abovementioned aspects the B phase in which the teat is exposed to a vacuum by opening of open liner bore has a duration selected from any one or more of the following:
Less than 480 ms, Less than 450 ms Less than 420 ms; Less than 400 ms; Less than 380 ms; Less than 360 ms; Less than 340 ms; Less than 320 ms; Less than 300 ms; at or about 300 ms; at or about 330 ms; above 220 ms; above 230 ms, above 240 ms; above 250 ms; above 260 ms; above 270 ms; above 280 ms; above 290 ms; above 300 ms; above 310 ms; above 320 ms; above 330 ms; above 350 ms; or within a range defined by any pair of the above listed durations.

In any of the abovementioned aspects the A phase has a duration selected from any one or more of the following:
Less than 180 ms; Less than 170 ms; Less than 160 ms; Less than 150 ms; Less than 140 ms; Less than 130 ms; Less than 120 ms; Less than 110 ms; Less than 100 ms; at or about any one of 100 ms, 110 ms, 115 ms, 120 ms, 125 ms, 130 ms, 135 ms, 140 ms, 145 ms, 150 ms; above 100 ms; above 110 ms, above 120 ms; above 130 ms; above 140 ms; above 150 ms; above 160 ms; or within a range defined by any pair of the above listed durations.

In any of the abovementioned aspects the C phase has a duration selected from any one or more of the following:
Less than 150 ms; Less than 140 ms; Less than 130 ms; Less than 120 ms; Less than 110 ms; Less than 130 ms; Less than 90 ms; Less than 80 ms; Less than 70 ms; at or about any one of 100 ms, 95 ms, 105 ms, 90 ms, 110 ms, 85 ms, 110 ms, 80 ms, 115 ms, 75 ms, 120 ms; above 70 ms; above 80 ms, above 90 ms; above 95 ms; above 100 ms; or within a range defined by any pair of the above listed durations.

In any of the abovementioned aspects the combined duration of the A and C phases are selected from any one or more of the following:
Less than 300 ms; Less than 280 ms; Less than 260 ms; Less than 240 ms; Less than 220 ms; Less than 200 ms; Less than 180 ms; at or about any one of 280 ms, 270 ms, 260 ms, 250 ms, 240 ms, 230 ms, 220 ms, 210 ms, 200 ms, 190 ms, 180 ms; above 170 ms; 180 ms; above 190 ms, above 200 ms; above 220 ms; above 230 ms; above 240 ms; above 250 ms; above 260 ms; above 270 ms; or within a range defined by any pair of the above listed durations.

In any of the abovementioned aspects the pulsation cycle has a repetition rate selected from any one of more of the following:

greater than 60 cycles per minute; greater than 70 cycles per minute; greater than 80 cycles per minute; greater than 90 cycles per minute; greater than 100 cycles per minute; at or about any one of 60, 70, 80, 89, 90, 100 cycles per minute; less than 70 cycles per minute; less than 80 cycles per minute; less than 90 cycles per minute; less than 100 cycles per minute; less than 110 cycles per minute, or at a rate within a range defined by any pair of the above listed frequencies.

Other cycle times or phase times are also possible in other embodiments.

The present invention also provides a milking machine or milking system, which is configured to perform a method as set out in relation any one of the abovementioned aspects of the invention. Most preferably the milking machine or system is generally of the type described in ISO 6690:2007 (or similar standards that precede or supersede this standard). In particular the milking machine preferably includes a claw and a plurality of milking cups.

In a further aspect there is provided a method of commissioning a milking system of the type including a plurality of milking cups each including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat,

a vacuum system in fluid communication the bore of the liner and the pulsation volume;
a source of positive air pressure air in fluid communication with the pulsation volume; and
a pressure regulating system configured to modulate the fluid pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to cause the liner bore to close to thereby stop milk flow from the teat and apply a compressive load to the teat; wherein the pressure regulation system is configured to operate in accordance with a modulation pattern of the pressure in the pulsation volume to defines a pulsation cycle including at least:
a “B phase” in which the teat is exposed to a vacuum by opening of open liner bore,”;
a “D” phase in which the liner bore is closed around the teat;
an “A phase” corresponding to a transition between the D phase and B phase; and
a “C phase” corresponding to a transition between the B phase and D phase;
   at least one milk receiving sub-system, in fluid communication with the liner bore and adapted to receive milk; said method including:
   setting an airflow parameter of at least the vacuum system to control the application of vacuum to the pulsation volume so as to obtain a predetermined duration for the A phase;
   controlling the application of air from the source of positive air pressure air to the pulsation volume to o the pulsation volume so as to obtain a predetermined duration for the C phase.

Setting the airflow parameter of at least the vacuum system to control the A phase can include setting a flow restriction between the vacuum system and the pulsation volume. Preferably it includes providing an orifice, or setting an orifice size, between the vacuum system and the pulsation volume.

The present invention also provides a milking machine or milking system, which is commissioned in accordance with the method of the abovementioned aspect of the invention. The milking machine or system can generally be of the type described in ISO 6690:2007 (or similar standards that precede or supersede this standard). In particular the milking machine preferably includes a claw and a plurality of milking cups.

### BRIEF DESCRIPTION OF THE DRAWINGS

Embodiments of the present invention will be described by way of non-limiting example only with reference to the accompanying drawings.

FIG. 1a is a reproduction of FIG. 1a of PCT/AU2017/050412 application and illustrates a milking system in which a milking method according to an embodiment of the present invention may be implemented.

FIG. 1b shows another exemplary system and replicates FIG. 13 of PCT/AU2017/050412.

FIG. 2 is equivalent to FIG. 8 of PCT/AU2017/050412 and illustrates a milking cup including an insert which is usable in an embodiment of the present application.

FIG. 3 illustrates a pulsation cycle, and shows the four phases the pulsation cycle in the embodiment of the present invention. This Figure is a partial reproduction of FIG. 5B of the applicant's earlier PCT application.

FIG. 4 shows a plot of actual measured pressure in the milking cluster over time. It should be noted that FIG. 4 illustrates pressure (positive pressure being in the positive direction and vacuum in the negative direction of the Y axis) and hence FIG. 4 is inverted compared to the illustration of the pulsation cycle of FIG. 3.

FIG. 5 is a plot of pressure in a modified pulsation cycle of an embodiment of the present invention.

FIG. 6 shows schematic drawing of milking clusters operating with different length air tubes as might be used in different embodiments of the present invention.

### DETAILED DESCRIPTION OF THE EMBODIMENTS

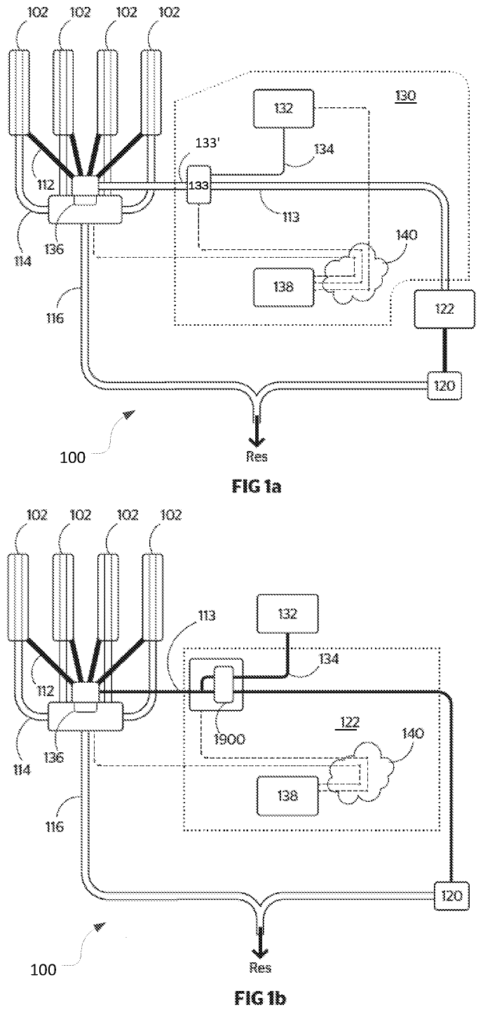

FIG. 1a to 1c of PCT/AU2017/050412 show a schematic illustration of aspects of a milking system 100 including a pressure compensation system. FIG. 1a of PCT/AU2017/050412 is reproduced here as FIG. 1A. The contents of PCT/AU2017/050412 are incorporated herein by reference for all purposes.

The milking system includes at least one (in this example 4) milking cup 102, details of which are shown in FIG. 1B. The milking cup 102 generally includes a shell 104 and a flexible liner 106. The liner 106 is generally tubular (but may have a non-round cross section, e.g. triangular) and includes a hollow bore 108. In use the bore receives the animal's teat at its top end for milking. The lower end of the bore 108 is connected to the milking claw 114, which in turn connects to a milk tube 116. The milk tube 116 connects the liner bore 108 to a vacuum system 120 in a manner that will be known to those skilled in the art. The liner 106 and shell 104 are sealed to each other in relative positions so as to create a pulsation volume 110 between them in. As is known in the art, in order to milk the animal the fluid pressure (vacuum) in the pulsation volume 110 is modulated control a pressure differential across the liner between its bore and the pulsation volume. Conventionally the vacuum in the pulsation volume is used to open the bore 108 of the liner 106 to enable milk to flow within the bore 108 towards the milk tube 116. Typically the milking claw 114 will have a manifold within it that connects several liners 106 to the milk tube 116.

The vacuum system 120 generally comprises a vacuum pump that is connected to, the bore of the liner 106 (possibly via intervening connections), and the pulsation volume 110 via a pressure regulating system 122. The pressure regulating system 122, which may conventionally be a pulsator, is configured to modulate the fluid pressure in the pulsation volume 110 of the milking cup(s) 102, to cause a milking operation on the teat. The pulsator 122 is fluidly connected to the pulsation volume 110 of one or more milking cup s by one or more long pulsation tube(s) 113 and respective short pulsation tubes 112. In this example the system has a 2×2 milking cluster and hence 2 long pulsation tubes are used. In other embodiments a different number of long pulsation tubes may be used. As will be known the pulsation cycle of the milking operation generally includes an “on” phase in which the vacuum that is applied to the liner bore is less than a vacuum applied to the pulsation volume. The pressure differential across the liner 106 causes its bore 108 to be opened so that the teat is exposed to the vacuum in the bore 108 to thereby enable milk flow from the teat. In an “off” phase the pressure in the pulsation volume 110 is increased relative to the “on” phase. Conventionally, the pulsation volume 110 is opened to atmosphere by the pressure regulation system 122. The pressure differential across the liner 106 causes the liner bore 108 to close.

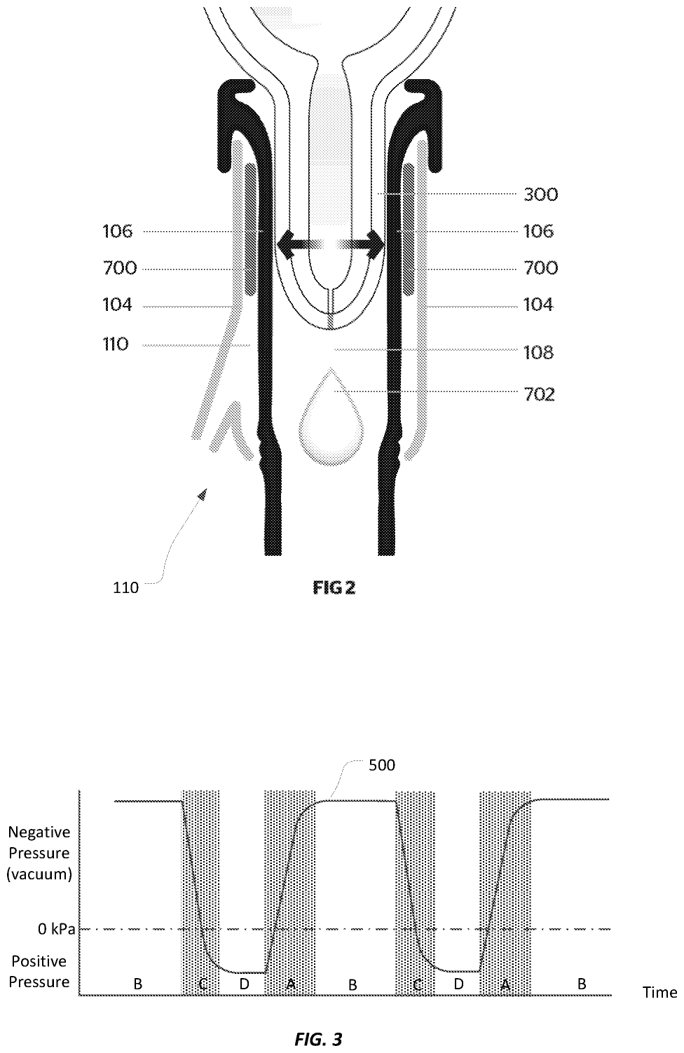

The system additionally includes a pressure compensation system 130. The pressure compensation system 130 primarily includes a source 132 of positive air pressure. The source could be a pump, compressor, compressed air tank, or other source of air at a pressure above atmosphere. The pressure of air delivered from the source can be controlled or set using any known mechanism, e.g. using a regulator, orifice plate, or the like. The mechanism may form part of the source 132 or be a stand-alone component of the pressure compensation system. The source 132 is in fluid communication with the pulsation volume 110 of (the or) each milking cup 102 via a positive pressure fluid delivery line 134, which in this example joins the long pulsation tube via valve 133. As will be described in further detail below the pressure compensation system 130 is used to selectively apply positive air pressure to the pulsation volume 110 during the “off” phase of the pulsation cycle, so that a compressive load is applied to the teat during at least part of the off cycle. To aid this process the pressure compensation system 130 further includes a:
a sensing system 136 for measuring a fluid parameter (typically pressure, volume or flow) related to a pressure in the bore 108; and
a controller 138 configured to control the pressure compensation 130 system to adjust a level of positive pressure applied to the pulsation volume 110 (see FIG. 2).

The controller 138 receives outputs from the sensing system 136 via a communications system 140. In the present diagrams the communication system 140 is illustrated to indicate logical connections between its elements. The system is may preferably be a wireless communications system if the distance between the sensing system components and/or controller is long as this may reduce wires in an already cluttered environment and may also minimise installation costs. However a wired communication system may be used. The communications system 140 may enable communication between the controller 138 and the one or more valves 133 or actuators of the pressure compensation system 130. The pressure compensation system 130 may be a stand-alone system (e.g. that may be retro-fitted to an existing milking system) or its functions and components could be integrated, mutatis mutandis, into the pressure regulating system 122. Furthermore the source of positive air pressure can be connected to any convenient location from which positive pressure can be delivered to the pulsation volume, in the manner required. For example, it may be connected directly to any one of the following locations:

An inlet to a pulsator;

A pulsation volume;

At a position adjacent to or along the length of either a long pulsation tube or a short pulsation tube;

A volume or manifold in fluid communication with any one of the above.

Indirect connection to such locations through a pipe, hose, valve or other means is also possible.

As noted above, the pressure compensation system 130 may be integrated into the pressure regulating system 122. FIG. 1b (which is a reproduction of FIG. 13 of PCT/AU2017/050412) shows a milking system including a pressure regulating system 122 modified in such a way. In the following description, like numbered components perform like tasks and will not be explained in detail again for the sake of brevity. In this embodiment the functions of the conventional pulsator are incorporated into a valve arrangement that controls the application of air at positive pressure and air at negative pressure (i.e. vacuum) to the pulsation tubes of the milking cluster. In this embodiment the milking system 100 includes a pressure regulating system 122 that has a three position valve arrangement 1900 coupled to:
the long pulsation tube 113 leading to the pulsation volume 110 of one or more milking cup s by one (or more) long pulsation tube(s) 113 and respective short pulsation tubes 112;
an airline leading to the source of positive pressure air 132;
an airline leading to the vacuum system 120.

The controller 138 is configured to control the operation of the pressure compensation system 122 to adjust the timing of operation of the valve 1900 to selectively deliver air of either positive air pressure, or vacuum to the pulsation volume 110 via the claw 114. A wired or wireless communications system 140 is employed for communicating data between the sensor system 136 and the controller 138, and the controller 138 and the valve arrangement 1900. The pressure regulating system can include one or more valve arrangements of any type including solenoid valves, diaphragm valve or the like. In a preferred form the pressure compensation system and pressure regulating system are integrated into an enhanced pulsator which selectively delivers positive and negative pressure air in a controlled manner.

FIG. 3 of the present application illustrates a plot 500 of the air pressure level applied to the pulsation volume 110 during the pulsation cycle implementing a pressure compensation scheme as disclosed in PCT/AU2017/050412.

The plot 500 takes a generally saw-toothed form. Transitions from the bottom of the cycle (point of lowest vacuum) to the top of the cycle are gradual, whereas, at the onset of vacuum release, a sharper drop occurs. As should be recognised by those skilled in the art, the cycle has four phases as follows:
“B” phase, or the “On” phase in which a relatively high vacuum level is applied to the pulsation volume 110. In this phase, the vacuum applied is sufficient for the liner 106 to be pulled open by the vacuum applied in the pulsation volume. Conventionally the vacuum applied will be in the vicinity of 46 kPa (say 40 to 50 kPa). Moreover the vacuum applied is the same as that applied to the milk tube 116. In preferred embodiments of the invention disclosed in PCT/AU2017/050412 the vacuum applied is less than 42 kPa. The vacuum applied can be less than 40 kPa. Preferably it is less than 38 kPa. Most preferably it is less than 36 kPa. A preferred form uses about 35 kPa.
“D” phase, or “off” phase, in which the pressure in the pulsation volume 110 is higher (i.e. vacuum decreased) than in the B phase. In this phase the liner 106 collapses around the teat. Conventionally, in this phase the pulsation volume is at atmospheric pressure.
“A” phase is a transition between the end of the D phase and the beginning of the B phase. During this phase the pulsator 122 connects the pulsation volume 110 to the vacuum system 120 to draw air out of the pulsation volume 110.
“C” phase is a transition from the B phase to the D phase. In this phase the vacuum in the pulsation volume 110 is released (i.e. air is allowed into the pulsation volume). Conventionally this is achieved by the pressure regulation system 122 opening the pulsation volume to atmosphere. Embodiments of PCT/AU2017/050412 modify this conventional process as follows:
During the C phase, instead of merely opening the pulsation volume to atmosphere, air under positive pressure is introduced into the pulsation volume 110. This causes the pressure in the D phase to be greater than atmospheric pressure. In turn this ensures that a positive compressive load is applied to the teat by the liner 106. FIG. 2 illustrates a milking cup 102 in which a teat 300 has been inserted. The resulting pressure modulation profile 500 within the pulsation volume 110 is illustrated in FIG. 3. After the B phase, the pulsator 122 releases the vacuum in the pulsation volume 110 and the C phase is entered. Shortly thereafter (on the order of 10 ms) the air under positive pressure is applied to the pulsation volume 110 and the pressure in the pulsation volume 110 increases. However, instead of equalising at atmospheric pressure, (˜101.3 kPa), pressure is increased to above atmospheric pressure. FIG. 3 illustrates the operation over several pulsation cycles. As will be appreciated the C phase is conventionally initiated by the pulsator 122 opening the long pulsation tube volume to atmosphere to release the vacuum. The A phase is initiated by connecting it back to vacuum. However in order to avoid the pulsator 122 releasing the positive pressure that is added to the pulsation volume 110 during the C and D phases the pulsator 122 is isolated from the pulsation volume 110 by a valve (valve 133 in this example). The introduction of positively pressurised air into the pulsation volume 110 is to apply compressive load to the teat to drive blood and lymphatic fluid upwards and out of the teat during the off phase of the pulsation cycle. To do this the compressive load applied is preferably be above blood pressure level, say about 0.8 to 1.2 N/cm², but may preferably be in a range of 2.0 N/cm² to 3.5 N/cm².

Control of the pressure compensation system 130 and in particular the determination of the level of positive pressure to be applied during the D phase, so as to achieve the desired compressive load on the teat can be performed by determining the pressure in the liner's bore 108, below the teat. The measurement, at least during the on (B) phase of the pulsation cycle is important as it has been determined by the inventor that the flow of milk in the liner bore 108 causes a reduction in the vacuum level actually experienced at the teat, regardless of the constant vacuum applied by the vacuum source 120. Thus the pressure can be determined by direct measurement of pressure in the bore 108, if suitable sensors are available, or measurement of any value that is related to this pressure. For example pressure could be measured at or near the lower end of the liner bore 108. Alternatively it could be measured in the chamber of the claw 114 or even the milk tube 116. In other forms the pressure can be estimated by measuring milk flow rate or milk volume at the same or similar locations. To this end, a sensing system is provided that includes at least one transducer to measure a fluid parameter. In this example the transducer is an air pressure sensor 136 in the claw 114. Since this chamber may be in fluid communication with the liners of several milking cup s, the single measurement will apply to all such cups. However, measurement may be performed on a cup-by-cup basis to enable individual control of compressive load on individual teats. The sensor 136 communicates the measured pressure data back to the controller 138 via a communications network 140. The communications network can be any type of suitable wired or wireless network. However a communications network using one or more wireless channels, (e.g. Bluetooth, Wi-Fi, ZigBee, IR, RFID, NFC, cellular technologies like 3G or 4G and the like) may be advantageously employed. In systems whose sensing systems include with multiple transducers per milking cluster, the communications components for a cluster can be shared amongst the transducers, or dedicated per-transducer communications components used. The pressure sensor is arranged to transmit measured pressure data to the controller 138. The data can be sent according to any scheme, for example it may be pushed by the sensor 136 or sent in response to a request from the controller 138. Moreover measurement can be performed continuously, intermittently or periodically depending on requirements.

The controller processes the received value and determines therefrom the pressure drop in the insert bore 108 and the necessary positive pressure to apply to the pulsation volume 110 in order to cause closing of the liner bore and application of the desired compressive load to the teat.

It was disclosed in PCT/AU2017/050412 that it is desirable to minimise the duration of the C phase of the pulsation cycle. This was seen to allow a longer D phase and possibly a longer B phase, which may be beneficial for milk production rates and animal health.

It has now been found that cup slip is controlled at low teat end vacuum (due to the application of positive pressure in the D phase) and positive pressure air is used to cause liner closing for at least part of the C phase, which has enhanced the ability to control the timing of the pulsation curve. For example the (A+B):(C+D) timing ratio can be controlled, as can the length of the B phase. Further been appreciated that the application of positive pressure to the pulsation volume 110 itself, may cause a decrease in C phase time, but to further decrease it, and further control the application of compressive load preferred embodiments of the present invention use a milking cup with a minimised pulsation volume 110, and or a means to control the collapse of the liner bore 108. In a preferred form this is achieved by providing an insert within the pulsation volume 110. The insert can be of the type described in Australian patent application 2008202821, the contents of which are herein incorporated by reference, and as illustrated schematically in FIG. 2 of the present specification. Such inserts are sold under the brand name of “SurePulse”.

FIG. 2 illustrates a milking cup 102, that is the same as that shown in FIGS. 1a and 1b, and the same features have been numbered with the same reference numerals. However the milking cup 102 has an insert 700 located in the pulsation volume 110. The insert 700 acts to minimise the air volume in the pulsation volume and acts as a collapsing means to cause sequential collapse of the liner against the teat from the lowermost part of the teat. Projections on the lower inner surface of the insert are provided that indent the liner to pinch the liner bore at a location below the tip of the teat. When positive air pressure is applied in the pulsation volume the liner 106 collapses from the position of the indentations so that compressive load is applied to the lowermost part of the teat before the application of compressive load higher up the teat. The use of the insert can assist in ensuring that the compressive load is initially applied to the lowermost 1 to 3 mm of the teat, and most preferably at the lowermost 2 mm.

By minimising the pulsation volume 110, the amount of air to be delivered to positively pressurise the pulsation volume is decreased. This enables faster application of the positive pressure and minimisation of the C phase. The reduced volume may also increase the accuracy of pressurisation of the pulsation volume as a lower volume of air needs to be applied.

Finally the insert 700 can have further beneficial effects on teat health by limiting outwards movement of the liner 106 during the B phase, and also assisting in controlling the liner closure during the C Phase. In other embodiments a profiled shell can be used in place of the inserts. When using such shells the inside of the shells is profiled to be dimensionally similar to the inside of the inserts described above. In this case the collapsing means can include a projection formed on a profiled inner surface of the shell which operates like the projection on the insert.

With the improved control over liner movement, the present inventor has now determined that the pulsation cycle can be modified to advantageously influence the milking process. Conventionally, and with embodiments of PCT/AU2017/050412 it is usual to operate the pulsation cycle with a B phase about 480 ms and D phase of around 300 ms. This permits a pulsation rate of approximately 60 cycles per minute when using a 120 ms A phase and 100 ms C phase. Such A and C phase times are achievable using an embodiment of the system disclosed in PCT/AU2017/050412. However, the present inventor has discovered that milk production during the B phase, in such a system and in conventional milking systems decreases towards the end of the B phase, and has determined that advantageously the length of the B phase can be reduced to generate a more efficient pulsation cycle.

Accordingly, embodiments of the present invention implement this realisation in combination with the application of positive air pressure during the C and D phases, as well as preferably the use of milking cup inserts or other means to control the closure of the milking cup liner during the C phase. The means to control the closure of the milking cup also act to limit unwanted distention of the liner during the A phase and subsequent rebound of the liner onto the teat. Moreover, in preferred embodiment system commissioning can be enhanced by the property that the closure of the liner during the C phase is able to be accurately controlled by the introduction for positive pressure air, but the opening of the liner is able to be controlled by controlling or setting the restriction of the air flow to and from the pulsation volume. Decoupling the mechanism which controls the opening, from the closing of the milking cup liner, embodiments of the present invention can be controlled closer to optimum operating parameters.

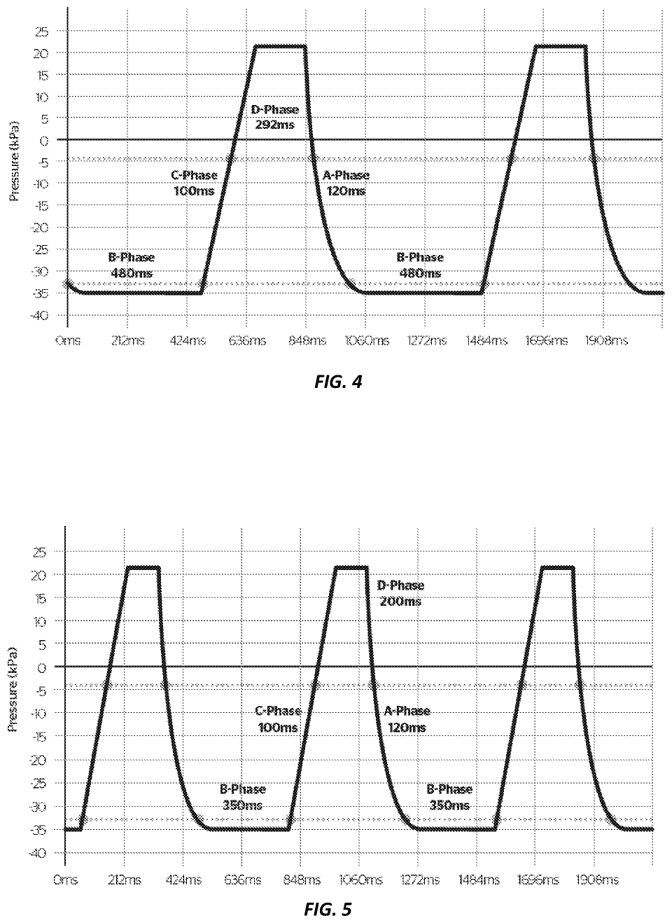

FIG. 4 shows a plot of the air pressure in the pulsation volume of a milking cup using an embodiment of the present invention. The system used for achieving this pulsation cycle is as disclosed in PCT/AU2017/050412 and includes inserts disclosed in Australian patent 2008202821. It should be noted that in the present plot both positive and negative air pressure values are illustrated, with positive values being above the zero point on the vertical axis and negative pressure values (i.e. vacuum) lying below the zero level. In essence the plot of FIG. 4 is inverted compared to the plot of FIG. 3. In the plot of FIG. 4, the horizontal dotted lines indicate the pressure level at which ISO 6690:2007(en) deems that transitions between each of the milking phases occur. That is, under the ISO standard D phase is the portion of the pulsation cycle which is above the dotted line at −4 kPa, and the B phase is below 4 kPa above maximum vacuum. In this case maximum vacuum is −35 kPa and accordingly the B phase begins and ends as the pressure level drops below −31 kPa and rises above the same value. This is indicated by the lower dotted line on FIG. 4. The C phase is the transition between the B phase and the D phase between the indicated dotted lines whereas the A phase is the transition between the D phase and B phase between the indicated dotted lines. As can be seen from the plot of FIG. 4, the A phase in the present embodiment is a duration 120 ms, the B phase 480 ms, the C phase 100 ms, and the D phase 292 ms. By the application of positive air pressure the C phase is held to a short duration and the rate of change of pressure is controlled to be relatively constant. It can also be seen that rather than only taking the D phase up to atmospheric pressure, additional air pressure of about 21 kPa is applied during the D phase. Next a relatively short 120 ms A phase is provided followed by a typical 480 ms B phase. The prevision of positive pressure during the D phase has been found to greatly assist in minimising cup slip and has enabled the reduction in the overall working vacuum applied during B phase. The constant rate of change in the C phase is believed to improve comfort for the cow and is caused by the application of positive air pressure to the pulsation volume 110. The A phase duration is controlled by the provision of an appropriate flow restriction in the pressure regulation system 122 so as to enable controlled application of vacuum to the pulsation volume. As will be discussed below, the level of the restriction may need to be varied in different embodiments of the present invention in order to compensate for the head loss provided by the particular pulsation tube length used. In embodiments of some aspects of the present invention the duration and/or rate of change characteristics of pressure in the A and C phases can be controlled independently in this manner. However, as can be seen from the timing diagram and table, the total pulsation cycle is still approximately 1 second and hence has a pulsation cycle rate of approximately 60 cycles per minute.

The present inventors have further found that after about 300 ms to 350 ms, the milk flow rate in the B phase starts to reduce, and if it is extended beyond 500 ms, the B phase or teat open time, no further milk is typically expressed.

FIG. 5 shows an example plot of a modified pulsation cycle according to an embodiment of the present invention. As can be seen the pulsation cycle is similar to that of FIG. 4 however the timing of the cycle differs. The D phase is \200 ms, which is relatively short compared to the embodiment of FIG. 4. The B phase is reduced to 350 ms in this example. Preferably, although not essentially, the A and C phases are controlled as described above. The shortened B phase eliminates the least efficient portion of the pulsation cycle in terms of milk production. Therefore, in combination with a relatively short D phase, embodiments of the present invention can be used at a higher pulsation cycle rate than previous systems.

Table 1, set out below, illustrates a range of exemplary pulsation cycle parameters and corresponding pulsation cycle rate for each. Other timings are also possible. In these examples, the A phase is set at 120 ms and the C phase at 100 ms.

TABLE 1

| | | Combined | | | Cycle | Cycles |
|---|---|---|---|---|---|---|
| A phase | C phase | B + D | B phase | D phase | time | per |
| (ms) | (ms) | phase (ms) | (ms) | (ms) | (ms) | minute |
| 120 | 100 | 780 | 480 | 300 | 1000 | 60 |
| 120 | 100 | 637 | 387 | 250 | 857 | 70 |
| 120 | 100 | 530 | 330 | 200 | 750 | 80 |
| 120 | 100 | 454 | 300 | 154 | 674 | 89 |
| 120 | 100 | 446 | 296 | 150 | 666 | 90 |
| 120 | 100 | 380 | 230 | 150 | 600 | 100 |

Those skilled in the art will recognise that the ISO standards stipulate that the minimum B phase applied during cow milking should be 300 ms and the minimum D phase should be 150 ms. Accordingly, embodiments of the present invention employing a combined A and C phase of approximately 220 ms can operate up to approximately 89 cycles per minute whilst staying within the ISO standards. Moreover, this can be achieved at significantly reduced teat end vacuum. Furthermore, the higher rate of milking will reduce cup slip by shortening time between D phases.

As noted above, the shorter B phase also eliminates the more inefficient part of the conventional B phase (i.e. where milking speed drops off) which may result in further efficiency benefits. Contrasting a 60 cycles per minute (cpm) pulsation cycle with an 89 cpm pulsation cycle as set out in table 1, the 60 cycles per minute has 60, B phases of 480 ms each. The B phases generally only show strong milk production for about 350 ms each, so for each minute of milking contains 21000 ms of actual milk production. Using the modified pulsation cycle at 89 cpm the total amount of time in which milk flows increases to 26700 ms (89×300 ms) per minute. Moreover the total time over which the teat is exposed to full vacuum in the B phase decreases from 28000 ms (60×480 ms) to 26700 ms (89×300 ms), which may further contribute to improved teat health. This improvement may, in preferred embodiments, be further enhanced by operation of the system at a relatively low vacuum level (e.g. −35 kPa).

As noted above, the A phase of the present pulsation cycle can advantageously be controlled by controlling the airflow parameters of the pressure regulation system such that the rate of change of pressure in the A phase is sufficiently rapid. This task can become more difficult if the air pipe length to the milking cluster is relatively long. Accordingly, the present inventors have determined that by providing a device which controls flow rate, such as by use an orifice of a predetermined flow characteristic, the behaviour of the pulsation volume during the A phase can be controlled. However, this control over the A phase by determining the flow restriction of outflowing vacuum does not interfere with the C phase timing. This is because C phase of the pulsation cycle is controlled by the application of positive pressure air. That is, because the C phase rate of change of pressure in the pulsation volume is not controlled by the orifice, rather it is controlled by the level of positive pressure applied to the air pipe, the setting of the C phase and A phase times and/or rate of change characteristics can be effectively decoupled.

Table 2 illustrates a variation in A phase duration as the length of the air pipe between the pressure regulation system and the cluster or pulsation volume increases.

TABLE 2

| Pipe | C phase duration | A phase duration (no |
|---|---|---|
| length | (determined by application | controlled restriction |
| (mm) | of positive pressure) | e.g. orifice) |
| 2200 | 100 | 120 |
| 2500 | 100 | 125 |
| 2800 | 100 | 130 |
| 3100 | 100 | 135 |
| 3400 | 100 | 140 |
| 3700 | 100 | 145 |
| 4000 | 100 | 150 |

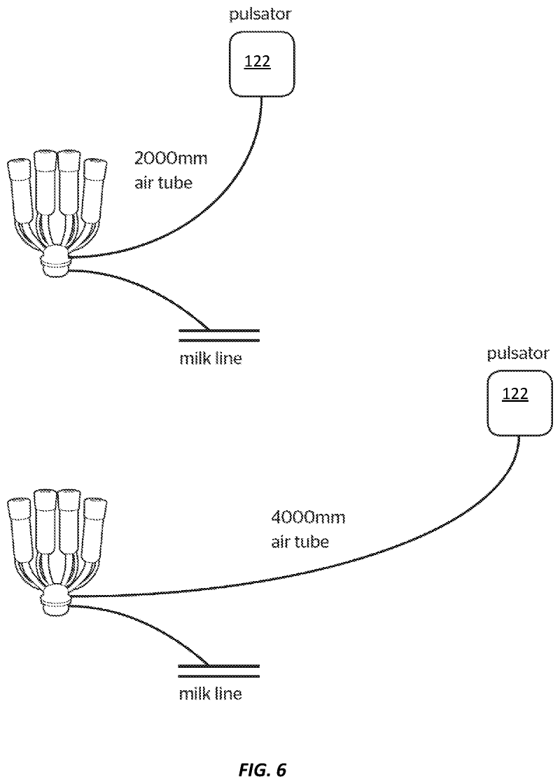

In order to counteract the increase in the A phase duration as the air tube length increases, the present inventors have determined that it is preferable to decrease the flow restriction at longer air pipe lengths. In one form, this is done by using a smaller internal diameter air tube for longer air tube runs, or by using a standard (e.g. 7 mm) air tube and applying a flow restriction such as an orifice at some point in the airflow path between the pressure regulation system and the pulsation volume for shorter air tube runs. For example, as illustrated in the top panel of FIG. 6, a 2000 mm air tube with a standard 7 mm internal diameter can be provided with a 6.5 mm diameter orifice plate to provide the equivalent flow restriction to a 7 mm diameter tube of 4000 mm length as shown in the bottom panel of FIG. 6.

As explained above, the duration of the A phase can be set during commissioning be setting the flow restriction in the flow path as a first step, and subsequently the C phase can be calibrated to achieve the desired C phase duration by setting the level of positive air pressure applied to the pulsation volume during the C phase. As will be appreciated, this effectively decouples the A phase from the C phase timing to enable the milking system to be set to reliably achieve the relatively short pulsation cycle times required in the preferred embodiments.

It will be understood that the invention disclosed and defined in this specification extends to all alternative combinations of two or more of the individual features mentioned or evident from the text or drawings. All of these different combinations constitute various alternative aspects of the invention.

1: A method of milking a cow using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:
applying a vacuum to the lower end of the liner;
modulating the pressure in the pulsation volume according to a pulsation cycle to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat wherein the pulsation cycle has a duration of less than 1 second.

2: A method of milking a cow using a milking cup of the type including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:
applying a vacuum to the lower end of the liner;
modulating the pressure in the pulsation volume according to a pulsation cycle to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to close the liner bore to thereby stop milk flow from the teat, said modulation including applying positive pressure to the pulsation volume to apply compressive load to the teat;
wherein the pulsation cycle includes a B phase in which the teat is exposed to a vacuum by opening of open liner bore, and said B phase has a duration of less than 450 ms.

3: The method of claim 2;
wherein the pulsation cycle is defined by a modulation pattern of the pressure in the pulsation volume wherein the pulsation cycle includes at least:
the “B phase” in which the teat is exposed to a vacuum by opening of open liner bore,”;
a “D” phase in which the liner bore is closed around the teat;
an “A phase” corresponding to a transition between the D phase and B phase; and
a “C phase” corresponding to a transition between the B phase and D phase;
wherein over a multiplicity of pulsation cycles the A phase and C phases have approximately constant duration.

4: The method of of claim 3;
wherein the duration of the C phase is controlled by the application of positive pressure air to the pulsation volume, and the duration of the A phase is controlled by a flow restriction to air entering or exiting the pulsation volume.

5: The method of claim 2 which includes providing collapsing means to cause sequential collapse of the liner against the teat from the lowermost part of the teat.

6: The method of claim 5 wherein collapsing means includes either or both of:
an insert placed within the pulsation volume
a profiled inner surface of the shell.

7: The method of claim 2 which further includes:
determining a pressure in the bore; and
applying a positive pressure to the pulsation volume in the off phase, wherein the level of positive pressure applied is determined on the basis of said determined pressure.

8: The method of claim 2 wherein the vacuum applied to the lower end of the liner is between 34 kPa and 38 kPa.

9: The method of claim 8 wherein the vacuum applied to the lower end of the liner is about 35 kPa.

10: The method of claim 2 which further includes applying compressive load to the teat in a manner that causes application of said load at the lowermost part of the teat before the application of compressive load higher up the teat.

11: The method of claim 5 wherein compressive load is initially applied to the lowermost 1 to 3 mm of the teat.

12: The method of claim 1 wherein the pulsation cycle has a duration selected from any one or more of the following:
less than 950 ms, less than 900 ms; less than 850 ms; less than 800 ms; less than 750 ms; less than 700 ms; less than 675 ms; at or about 674 ms; 600 ms or above; 650 ms or above; 700 ms or above; 7500 ms or above; 800 ms or above; 850 ms or above; 900 ms or above; 950 ms or above.

13: The method of claim 2 wherein the B phase in which the teat is exposed to a vacuum by opening of open liner bore has a duration selected from any one or more of the following:
less than 480 ms, less than 450 ms, less than 420 ms; less than 400 ms; less than 380 ms; less than 360 ms; less than 340 ms; less than 320 ms; less than 300 ms; at or about 300 ms; at or about 330 ms; above 220 ms; above 230 ms, above 240 ms; above 250 ms; above 260 ms; above 270 ms; above 280 ms; above 290 ms; above 300 ms; above 310 ms; above 320 ms; above 330 ms; above 350 ms.

14: The method of claim 13 wherein the A phase has a duration selected from any one or more of the following:
less than 180 ms; less than 170 ms; less than 160 ms; less than 150 ms; less than 140 ms; less than 130 ms; less than 120 ms; less than 110 ms; less than 100 ms; at or about any one of 100 ms, 110 ms, 115 ms, 120 ms, 125 ms, 130 ms, 135 ms, 140 ms, 145 ms, 150 ms; above 100 ms; above 110 ms, above 120 ms; above 130 ms; above 140 ms; above 150 ms; above 160 ms.

15: The method of claim 14 any one of the preceding claims wherein the C phase has a duration selected from any one or more of the following:
less than 150 ms; less than 140 ms; less than 130 ms; less than 120 ms; less than 110 ms; less than 130 ms; less than 90 ms; less than 80 ms; less than 70 ms; at or about any one of 100 ms, 95 ms, 105 ms, 90 ms, 110 ms, 85 ms, 110 ms, 80 ms, 115 ms, 75 ms, 120 ms; above 70 ms; above 80 ms, above 90 ms; above 95 ms; above 100 ms.

16: The method of claim 2 any one of the preceding claims wherein the combined duration of the A and C phases are selected from any one or more of the following:
less than 300 ms; less than 280 ms; less than 260 ms; less than 240 ms; less than 220 ms; less than 200 ms; less than 180 ms; at or about any one of 280 ms, 270 ms, 260 ms, 250 ms, 240 ms, 230 ms, 220 ms, 210 ms, 200 ms, 190 ms, 180 ms; above 170 ms; 180 ms; above 190 ms, above 200 ms; above 220 ms; above 230 ms; above 240 ms; above 250 ms; above 260 ms; above 270 ms.

17: The method of claim 1 wherein the pulsation cycle has a repetition rate selected from any one of more of the following:
greater than 60 cycles per minute; greater than 70 cycles per minute; greater than 80 cycles per minute; greater than 90 cycles per minute; greater than 100 cycles per minute; at or about any one of 60, 70, 80, 89, 90, 100 cycles per minute; less than 70 cycles per minute; less than 80 cycles per minute; less than 90 cycles per minute; less than 100 cycles per minute; less than 110 cycles per minute.

18: A method of commissioning a milking system of the type including a plurality of milking cups each including a shell and a flexible liner, said liner including a hollow bore for receiving an animal's teat at a top end thereof, and for being connected to a vacuum source at the lower end thereof; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat,
a vacuum system in fluid communication the bore of the liner and the pulsation volume;
a source of positive air pressure air in fluid communication with the pulsation volume; and
a pressure regulating system configured to modulate the fluid pressure in the pulsation volume to cause a milking operation on a teat of an animal that is inserted into the top end of the bore; said modulation including an “on” phase in which the vacuum applied to the liner bore is less than a vacuum applied to the pulsation volume to thereby enable milk flow from the teat, and an “off” phase in which the pulsation volume is at an increased pressure relative to the “on” phase to cause the liner bore to close to thereby stop milk flow from the teat and apply a compressive load to the teat; wherein the pressure regulation system is configured to operate in accordance with a modulation pattern of the pressure in the pulsation volume to defines a pulsation cycle including at least:
a “B phase” in which the teat is exposed to a vacuum by opening of open liner bore,”;
a “D” phase in which the liner bore is closed around the teat;
an “A phase” corresponding to a transition between the D phase and B phase; and
a “C phase” corresponding to a transition between the B phase and D phase;
at least one milk receiving sub-system, in fluid communication with the liner bore and adapted to receive milk; said method including:
setting an airflow parameter of at least the vacuum system to control the application of vacuum to the pulsation volume so as to obtain a predetermined duration for the A phase;
controlling the application of air from the source of positive air pressure air to the pulsation volume to so as to obtain a predetermined duration for the C phase.

19: A method of claim 18 wherein setting an airflow parameter of at least the vacuum system to control the A phase includes setting a flow restriction between the vacuum system and the pulsation volume.

20: A method of claim 18 wherein setting an airflow parameter of at least the vacuum system to control the A phase includes providing an orifice between the vacuum system and the pulsation volume.
